(19) United States
(12) Patent Application Publication
(10) Pub. No.: US 2015/0248912 A1
(43) Pub. Date: Sep. 3, 2015

(54) FUSED DATA STORAGE DEVICE COMPONENTS

(71) Applicant: Seagate Technology LLC, Cupertino, CA (US)

(72) Inventors: Hans Leuthold, Santa Cruz, CA (US); Lynn Bich-Quy Le, San Jose, CA (US); Chris M. Woldemar, Santa Cruz, CA (US)

(73) Assignee: Seagate Technology LLC, Cupertino, CA (US)

(21) Appl. No.: 14/194,642

(22) Filed: Feb. 28, 2014

(51) Int. Cl. G11B 19/20; H02K 7/00

(52) U.S. Cl. CPC G11B 19/2009; H02K 7/003

(57) ABSTRACT

Provided herein is an apparatus, including a first part of a data storage device and a second part of the data storage drive. The second part of the data storage device is fused to the first part substantially throughout opposing surfaces of the first part and the second part, where the opposing surfaces are in contact with each other.

### BACKGROUND

An electric motor may use stators, magnets, and/or coils to rotate an object. For example, a motor may rotate data storage disks used in a disk drive storage device. The data storage disks may be rotated at high speeds during operation using the stators, magnets, and/or coils. For example, magnets and coils may interact with a stator to cause rotation of the disks relative to the stator.

In some cases, electric motors are manufactured with increasingly reduced sizes. For example, in order to reduce the size of a disk drive storage device, the size of various components of the disk drive storage device may be reduced. Such components may include the electric motor, stator, magnets, and/or coils. The precision at which the components are manufactured can affect the reliability and performance of the electric motor.

### SUMMARY

Provided herein is an apparatus, including a first part of a data storage device and a second part of the data storage drive. The second part of the data storage device is fused to the first part substantially throughout opposing surfaces of the first part and the second part, where the opposing surfaces are in contact with each other.

These and other features and aspects may be better understood with reference to the following drawings, description, and appended claims.

### DRAWINGS

FIG. 1 provides a cross-sectional side view of a spindle motor for a hard disk drive, according to one aspect of the present embodiments.

FIG. 2A provides a cross-sectional side view of a laser weld.

FIG. 2B provides a cross-sectional side view of two parts subsequent to an electric resistance weld, according to one aspect of the present embodiments.

FIG. 3 provides a cross-sectional side view of a shaft during welding to a thrust cup, according to one aspect of the present embodiments.

FIG. 4 provides a cross-sectional side view of a shaft during welding to a cap, according to one aspect of the present embodiments.

FIG. 5 provides a flow chart of a process for coupling a first part and a second part according to one aspect of the embodiments.

FIG. 6 illustrates an exemplary diagram of a hard drive according to one aspect of the embodiments.

### DESCRIPTION

Before particular embodiments are described in greater detail, it should be understood by persons having ordinary skill in the art that the concepts presented herein are not limited to the particular embodiments described and/or illustrated herein, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood by persons having ordinary skill in the art that the terminology used herein is for the purpose of describing particular embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps. For example, “first,” “second,” and “third” elements or steps need not necessarily appear in that order, and the elements or steps need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Unless defined otherwise, all technical and scientific terms used herein have the same meaning as commonly understood by persons of ordinary skill in the art.

Components of a data storage device (e.g., a hard disk drive (HDD) or a motor of a HDD) may be attached to one another in a variety of ways. Laser welding is used to attach components of a motor to one another. Laser welding may be used in conjunction with and to strengthen press fit joints. However, the use of laser welding produces bulges and distortions in the surfaces of the components that are welded together. For example, melted surface portions of two components may solidify to an irregular chunk of material referred to as a “nugget.”

As devices are made smaller and the materials made thinner, the distortions caused by the laser weld may have more significant negative impacts on the smaller and thinner parts. Also, with the use of thinner materials, the effectiveness of a press fit may become limited. For example, a press fit may be difficult to use due to components distorting (e.g., buckling) upon an attempt to press fit the components together.

As a result of the disadvantages of laser welding, components of a motor may be made as a single piece, which is often more difficult to manufacture. The manufacturing of multiple pieces as a single piece typically involves using relatively softer materials. For example, softer free machining steel such as 430 type, SFDS, SF20, and 20F steels may be used.

Embodiments allow the manufacture of different parts separately with harder and stronger materials. Embodiments further allow for the sufficiently strong coupling of thinner materials thereby enabling reduced device sizes.

In some embodiments, electric resistance welding is used to couple data storage device components. Electric resistance welding may include welding that produces coalescence of connecting or “faying” surfaces where heat to form the weld is generated by the electrical resistance of the material combined with the time and the force used to hold the material together during the welding.

The use of electric resistance welding allows for the components (e.g., of a motor) to be joined to one another while avoiding bulges and distortion (e.g., of laser welding). Electric resistance welding may involve bringing two pieces of conductive material (e.g., two pieces of metal) into contact and applying a current. The current creates heat at the interface between the two pieces of conductive material, which thereby melts and fuses the conductive materials at the contact between the two materials. In some embodiments, a welding technique (e.g., upset welding) is used which produces coalescence of two parts (e.g., simultaneously) over the area of abutting surfaces and/or progressively along a joint, by heat obtained from resistance to electrical current through the area where the surfaces of two parts are in contact. In some embodiments, the two pieces may be coupled via a variety of welding techniques including, but not limited to, resistance seam welding, butt welding, resistive spot welding, upset welding, projection welding, and flash welding. Embodiments thus allow manufacture of separate pieces of stronger materials and assembly thereafter. For example, a ground shaft may be made and then fused with a thrust cup, as described herein.

Embodiments further allow for the use of enhanced bearing materials (e.g., stronger and harder). It is noted that the strength of bearing surfaces may be critical to motor performance. For example, it may be desirable for one of the surfaces of the bearing to be hardened and ground if the other surface of the bearing is to be machined. Embodiments allow the use of harder materials including 420 steel, 420J2 steel, and 440 steel.

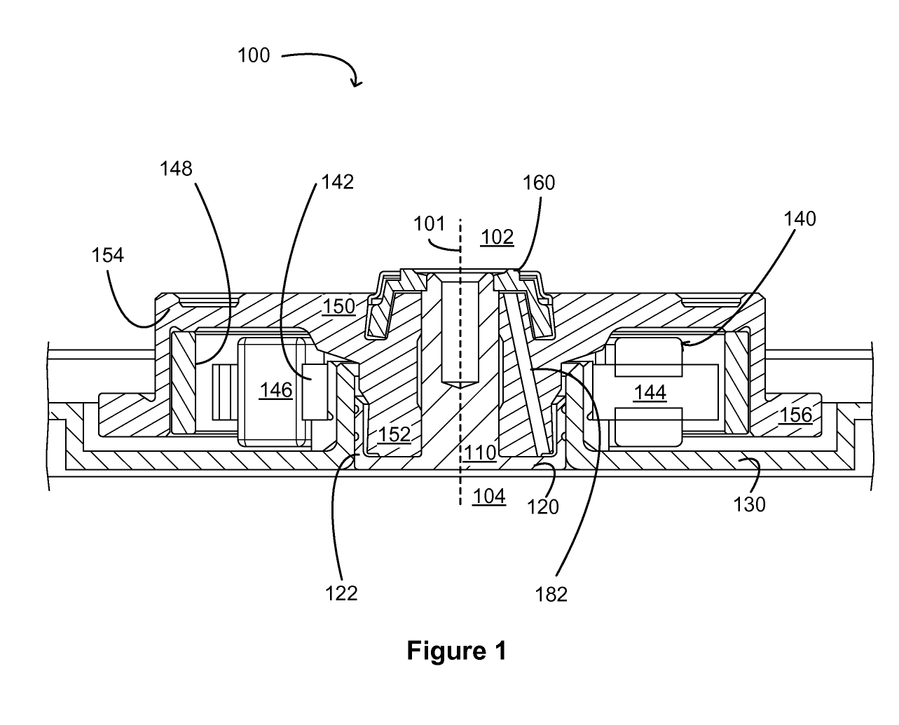

FIG. 1 provides a cross-sectional side view of a spindle motor for a hard disk drive, according to one aspect of the present embodiments. FIG. 1 provides cross-sectional view of a motor (e.g., FDB motor) including parts or components that are fused according to embodiments, as described herein. However, it should be understood that the particular embodiments provided in FIG. 1 are merely examples, and the particular embodiments are not limiting.

The FDB motor 100 in FIG. 1 includes a stationary component and a rotatable component positioned for relative rotation about a bearing system. With respect to the stationary component, the stationary component may include a shaft 110 extending from a first axial end 102 of the FDB motor 100 to a second axial end 104 of the FDB motor 100, through which the shaft 110 passes a centerline axis 101 of the FDB motor 100. The shaft 110 may be coupled to a thrust cup or cup 120 at the second axial end 104 of the FDB motor 100, which cup 120, in turn, may be coupled to a base 130 through a wall 122 of the cup 120. The stationary component may further include a stator assembly 140 coupled to the base 130, which stator assembly 140 may include a yoke 142, a plurality of stator teeth 144, and a plurality of field coils 146 singly disposed on the plurality of stator teeth 144. Adhesive bonds may be used to couple the foregoing components, but coupling may also be accomplished with epoxy, welds, or fasteners, as desired. One or more sub-components (e.g., shaft 110) of the stationary component may be coupled to a housing for the FDB motor 100, or a housing component (e.g., top cover), which may significantly improve structural stiffness of the system while compromising little in axial space.

With respect to the rotatable component of the FDB motor 100 in FIG. 1, the rotatable component may include a sleeve-hub assembly 150 having a sleeve 152 sub-component coupled to a hub 154 sub-component. As shown, the sleeve-hub assembly 150 may be an integral sleeve-hub assembly 150 having a sleeve 152 portion and a hub 154 portion. The sleeve 152 of the sleeve-hub assembly 150 may be rotatably fitted within the cup 120 such that the cup wall 122 of the cup 120 extends over a substantial axial length of the sleeve 152, including over at least 20%, 30%, 40%, 50%, 60%, 70%, or 80% of the axial length of the sleeve 152, which may function to minimize angular displacement of the sleeve-hub assembly. The sleeve 152 may include a cylindrical bore through its center in which the shaft 110 may be fitted. The hub 154 of the sleeve-hub assembly 150 may include a hub flange 156 configured to support one or more disks (e.g., magnetic recording media) of a disk pack for rotation. The hub 154 may further include a back iron or magnet 148 coupled to the hub 154, which back iron or magnet 148 cooperates with the stator assembly 140 to induce rotation of the hub 154 and the disk pack. Adhesive bonds may be used to couple the foregoing components, but coupling may also be accomplished with epoxy, welds, or fasteners, as desired.

Sleeve-hub assembly 150 may further include recirculation channel 182 which is part of a recirculation system for the lubricating fluid (e.g., lubricating oil), wherein the recirculation system is primarily positioned between the stationary component and the rotatable component, and wherein the recirculation system includes the bearing system and a fluid circuit of FDB motor 100. As shown in FIG. 1, the recirculation channel 182 may be configured such that the recirculation channel 182 is angled or not parallel to the shaft 110 and/or centerline axis 101. In such a configuration, the recirculation channel 182 near the first axial end 102 of the FDB motor 100 may be at an inner radius and the recirculation channel 182 near the second axial end 104 of the FDB motor 100 may be at an outer radius, wherein the inner radius and the outer radius represent relative radial distances from the shaft 110 and/or centerline axis 101. The recirculation channel 182 may be configured such that the recirculation channel 182 is parallel to the shaft 110 and/or centerline axis 101. In such a configuration, the recirculation channel 182 near the first axial end 102 of the FDB motor 100 and the recirculation channel 182 near the second axial end 104 of the FDB motor 100 are at equal radial distances from the shaft 110 and/or centerline axis 101.

A limiter cap or top cap 160 may be employed to limit axial movement of the rotatable component with respect to the stationary component. In the example shown, the facing surfaces of the limiter 160 and the sleeve-hub assembly 150 may limit the axial movement. In some embodiments, top cap 160 is attached to, or in contact with, at least one of the shaft 110 and a top cover (not shown).

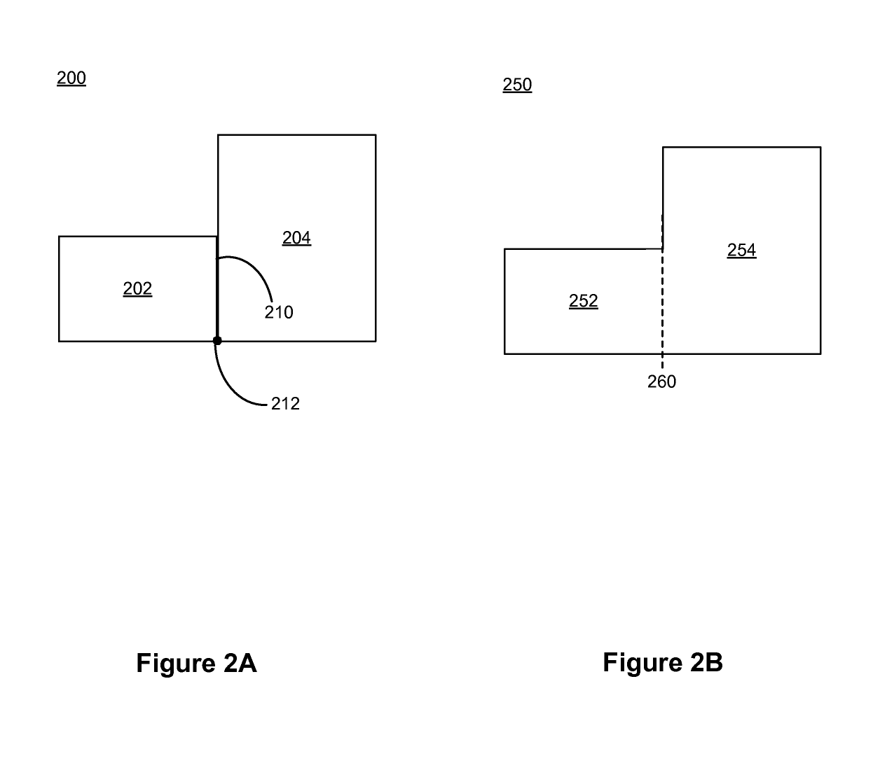

FIG. 2A provides a cross-sectional side view of a laser weld. FIG. 2A depicts two parts after a laser weld and the bulges and distortions on the surface after the laser weld. Laser welding may cause local and global distortion for overall assembly of parts 202 and 204. As parts 202 and 204 are made smaller and thinner the negative impacts of the distortions of the laser welding increase.

The laser weld is largely a surface weld of parts 202 and 204. The laser welding may cause a portion of a surface of parts 202 and 204 to become molten. For example, laser welding exposes the surface to external heat that melts respective portions of the surfaces of each part and as the molten portions cool, a deformation forms in the surface. The laser weld may look like a series of circles that are over lapping each other. The circles may have a width depending on the spot size of the laser.

The laser weld thus liquefies a molten puddle where material from part 202 and part 204 comingles which cools and creates weld nugget 212. The weld nugget 212 hides the joint line of parts 202 and 204. Laser welding thus welds the surface of parts 202 and 204 while leaving the portions of parts 202 and 204 that are in contact at interface 210 between parts 202 and 204 largely unchanged.

In some cases, laser welding may be applied to a single side of a joint due to laser line of sight access to a single side of a part assembly. The laser welding of a single side may not be as strong as a double-sided weld or a weld according to embodiments, as described herein.

FIG. 2B provides a cross-sectional side view of two parts subsequent to an electric resistance weld, according to one aspect of the present embodiments. FIG. 2B depicts two parts that are cross-sectionally fused, comingled, and/or coalesced at a point of contact after an electric resistance weld. Electrical resistance welding creates heat via current flow at the point of contact or the interface 260 between part 252 (e.g., thrust cup 120 in FIG. 1) and part 254 (e.g., shaft 110 in FIG. 1). Electric resistance welding does not substantially produce bulges and surface distortions of the surfaces of parts 252 and 254. Electric resistance welding may include upset welding, resistance seam welding, resistive spot welding, and butt welding.

In some embodiments, the surfaces of parts 252 and 254 may be substantially locally melted and fused or merged. Parts 252 and 254 may thus be cross sectionally fused at the point of contact or interface 260 between parts 252 and 254. The electrical resistance welding of respective portions of parts 252 and 254 may overwhelm any oxide layers of the respective portions and comingle the atoms at the interface 260 between parts 252 and 254 thereby causing atomic bonding to occur at the interface 260 between parts 252 and 254.

The welding may thus merge or fuse the opposing surfaces of part 252 and part 254 (e.g., the surfaces that are in contact prior to the welding). In some embodiments, a weld between a shaft and a thrust cup extends substantially throughout the area of contact of the opposing surfaces of the shaft and the thrust cup. In various embodiments, a weld between a shaft and a top cap extends substantially throughout the area of contact of the opposing surfaces of the shaft and the thrust cup. The cross sectional fusing of parts 252 and 254 may be visible upon taking a cross section (e.g., via a microscope and/or an optical magnification device).

Cross sectional fusing is different from laser welding. For example, cross sectional fusing does not produce weld nuggets or distortions and bulges in the surfaces of the components. The cross sectionally fused portions are fused substantially over the area of contact of the parts. In other words, the cross-sectionally fused portion may extend substantially throughout the area of contact of the parts. With cross sectional fusing, the opposing surfaces of the two parts that are in contact are fused.

In some embodiments, part 254 may be a shaft (e.g., ground and hardened) and part 252 may be a thrust cup (e.g., thrust cup 304). It is noted that the use of a ground shaft allows for tighter tolerances and stronger materials. In some embodiments, the shaft may be machined out (e.g., via a lathe) to a rough dimension and then heat treated to increase the hardness of the material. The outer diameter of the shaft may then be ground. In some embodiments, the shaft may have a shoulder. The face of the shoulder and the outer diameter of the shaft may be ground concurrently.

In various embodiments, the weld may result in a substantially constant radius outside of part 254, where the substantially constant radius is proximate to part 252 or joint of parts 252 and 254. In contrast, the aforementioned radius between the two parts with a laser weld would be non-constant due to variations in the melting of the two parts (e.g., a non-uniformity of a weld nugget).

In some embodiments, the seam or joint of parts 252 and 254 may be visible at the surfaces of parts 252 and 254 while parts 252 and 254 are cross-sectionally joined or fused below the respective surfaces of parts 252 and 254. In some embodiments, the seam may have a discoloration in the cross section where material from part 252 has comingled with material from part 254. In some embodiments, interface 260 between parts 252 and 254 may include a laminate of material, which is made of a combination of the materials of parts 252 and 254. In some embodiments, parts 252 and 254 may be made of similar materials or the same material. In some embodiments, parts 252 and 254 may be made of steels of the same or different types, which are fused in the area of contact between part 252 and part 254 (e.g., at interface 260).

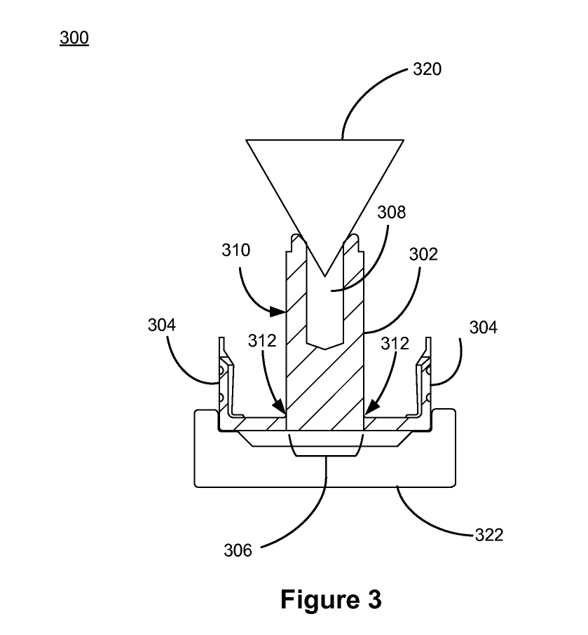

FIG. 3 provides a cross-sectional side view of a shaft during welding to a thrust cup, according to one aspect of the present embodiments. In some embodiments, FIG. 3 depicts an exemplary configuration of a shaft, a thrust cup, and respective electrodes during electric resistance welding.

Thrust cup 304 may have an annular shape. Thrust cup 304 may have an opening 306 configured for insertion of a portion of shaft 302. Thrust cup 304 is coupled to electrode 322 and shaft 302 is coupled to electrode 320. Shaft 302 may be inserted into thrust cup 304 in a substantially perpendicular manner. Shaft 302 and thrust cup 304 may then be in contact at interface 312 of the opposing or connecting surfaces of shaft 302 and thrust cup 304. In some embodiments, shaft 302 may be positioned in thrust cup 304 to ensure an accurate axial location of shaft 302. Electrodes 320 and 322 may have relatively larger contact areas with parts than the portions of shaft 302 and thrust cup 304 that are in contact (e.g., at interface 312).

An electric resistance weld may then be performed by applying current flowing from electrode 320 to electrode 322 or vice versa from electrode 322 to electrode 320. In some embodiments, the contact areas of electrodes 320 and 322 are large enough such that substantially little amounts of local heat are created at the contacts points between electrodes 320 and 322 and shaft 302 and thrust cup 304, respectively. In various embodiments, interface 312 or the contact area between shaft 302 and thrust cup 304 is sufficiently small that the current density through the contact area heats and melts respective portions of shaft 302 and thrust cup 304 thereby welding a portion of shaft 302 to thrust cup 304. For example, a current of 200 amps may be applied for a millisecond or 500 amps may be applied for a millisecond thereby causing the contact surface or interface 312 between shaft 302 and thrust cap 304 to melt and fuse (e.g., in a limited way). The welding thereby couples (e.g., fuses) shaft 302 and thrust cup 304 together.

In some embodiments, the fusing of respective portions of shaft 302 and thrust cup 304 forms an adhering interface between shaft 302 and thrust cup 304. The adhering interface is substantially coextensive with the area of contact between shaft 302 and thrust cup 304 and the adhering interface is stronger than a deformation-free friction joint therebetween. The deformation-free friction joint is a force-fitted friction joint (e.g., a press fit) that is formed by pressing the two parts together in a well known fashion without exceeding the elastic bending limits of either part, such that both parts return to their original shapes after being press-fitted together.

In some embodiments, the extension of the weld is substantially greater than the depth of the weld (e.g., a ratio of 100:1). For example, the extension of the weld horizontally between shaft 302 and thrust cup 304 may be greater in length than the vertical height of weld.

In some embodiments, electrode 320 has a chamfer configured for increased surface contact with shaft 302. Shaft 304 may have an opening 308 for a screw or similar fastener and electrode 320 may be shaped in a substantially similar manner to have increased surface area contact with a substantial portion of opening 308 of shaft 302.

In various embodiments, electrode 320 may be configured to apply current to shaft 302 via a curricular or ring contact (not shown) in contact with an outer portion 310 of shaft 302. In some embodiments, shaft 302 may be held (e.g., and centered) with an object of non-conductive material or conductive material of opposite polarity. For example, a ring contact may be created by holding the shaft with a chuck like electrode device configured for positioning and holding the shaft in place and further configured for providing a large cylindrical electrical contact area.

Embodiments allow components, including shaft 302 and thrust cap 304, to be made out of stronger and hardened materials. Embodiments further allow shaft 302 and thrust cap 304 to be made as two separate pieces, thereby allowing grinding of shaft 302 during fabrication.

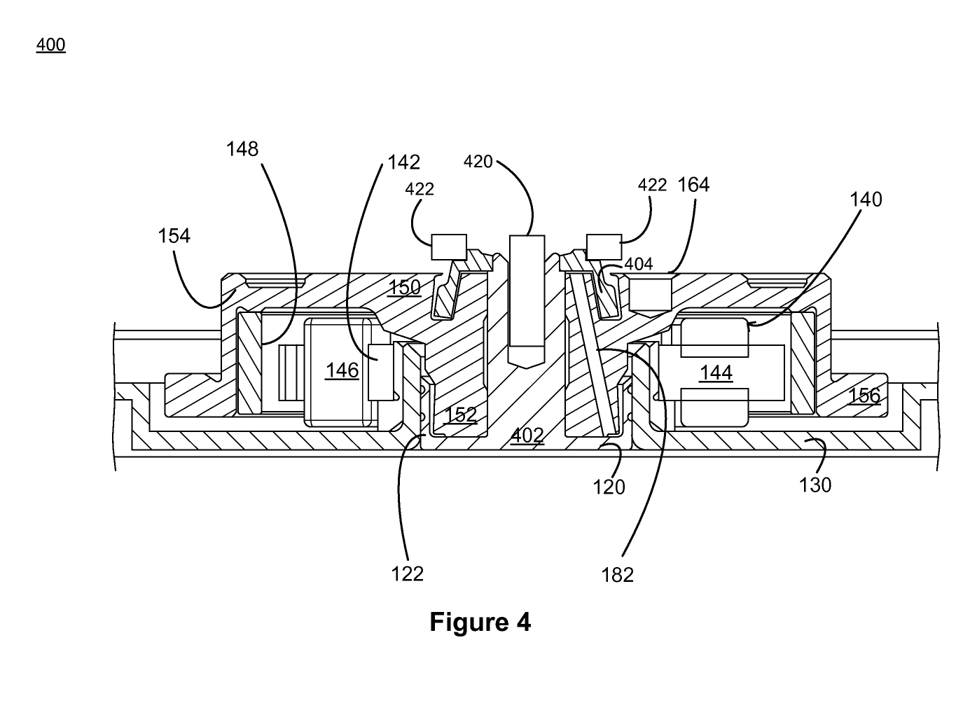

FIG. 4 provides a cross-sectional side view of a shaft during welding to a top cap, according to one aspect of the present embodiments. FIG. 4 depicts an exemplary configuration of a shaft, a top cap or limiter cap, and respective electrodes during electric resistance welding.

In some embodiments, after further assembly of the motor (e.g., after fusing of shaft 302 and thrust cup 304 and coupling of hub 154, etc.), an electrode 420 is coupled to shaft 402 and electrode 422 is coupled to top cap 404. Electrode 422 may be annular in shape and be coupled to an annular surface of top cap 404. Current is applied to electrode 420 or electrode 422 thereby causing welding of shaft 402 and top cap 404 at the interface between shaft 402 and top cap 404, as described herein.

In some embodiments, electrode 422 may contact and hold top cap 404 in place. In some embodiments, the amount of axial play of hub 154 with respect to top cap 402 may be measured prior to welding top cap 402 to shaft 404. In some embodiments, the coupling of the shaft and the top cap allows configuration of the axial gap of a motor. Shaft 402 and top cap 404 may be coupled (e.g., welded) without affecting hub 154.

In some embodiments, the electrode 420 may contact the shaft 402 from the thrust cup 120 side of the shaft 402 which opposes the top cap 404.

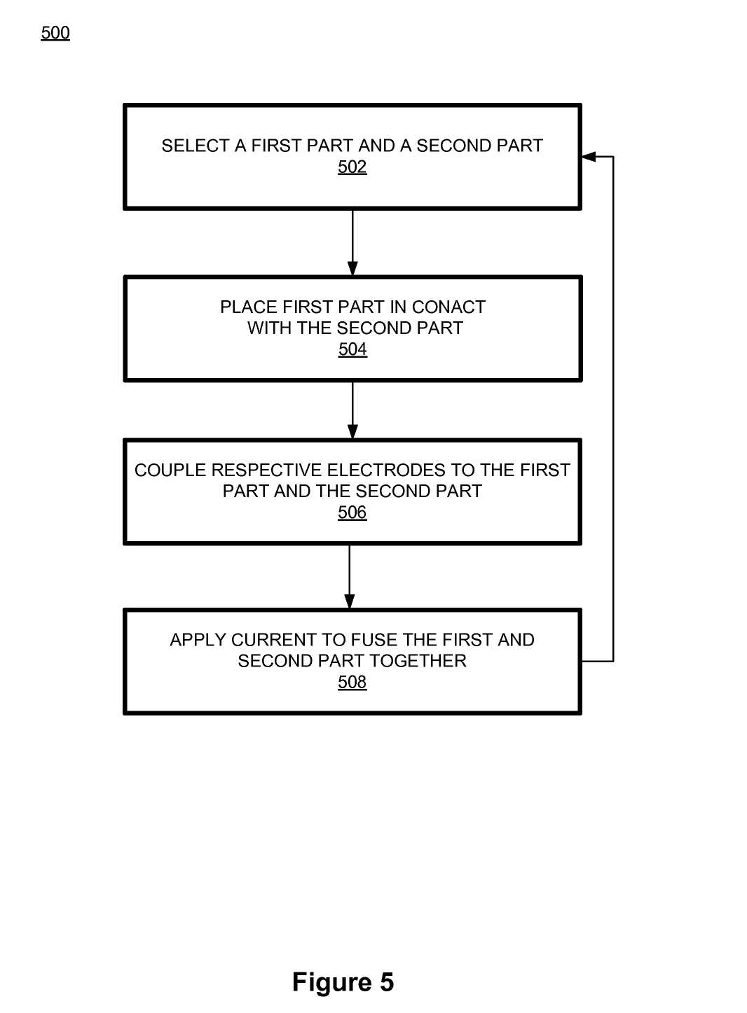

FIG. 5 provides a flow chart of a process for coupling a first part and a second part according to one aspect of the embodiments. In some embodiments, FIG. 5 depicts a process for fusing (e.g., welding) two parts of a data storage device (e.g., a hard disk drive).

At block 502, a first part and a second part are selected. In some embodiments, the first part and the second part may parts of a hard disk drive. In various embodiments, the first part and the second part may be a shaft and a thrust cup respectively. In some embodiments, the first and second part may be a shaft and a top cap respectively.

At block 504, the first part is put in contact with the second part. In some embodiments, the first part is a shaft, which is inserted into an opening in a thrust cup, as described herein. In some embodiments, the first part is a top cap, which is put into contact with a shaft (e.g., on top of the shaft), as described herein.

At block 506, respective electrodes are coupled to the first part and the second part. In some embodiments, the first part is a shaft and a respective electrode is coupled to the surface and/or an opening of the shaft. In some embodiments, the first part is a shaft and a respective electrode is coupled to an outer portion (e.g., outer diameter) of the shaft.

In various embodiments, the second part may be a thrust cup and a respective electrode is coupled thereto. In various embodiments, the second part may be a top cap and a respective electrode is coupled thereto (e.g., onto an annular surface of the top cap).

At block 508, a current is applied to fuse (e.g., weld) the first part and the second part. In some embodiments, the application of the current causes heating and melting of respective portions of the first part and the second part at the point of contact between the first part and the second part. Respective portions of the first part and the second part may thus be cross-sectionally fused or comingled (e.g., atomically). In some embodiments, the weld extends substantially throughout opposing surfaces of the first part (e.g., shaft) and the second part (e.g., thrust cup or top cap).

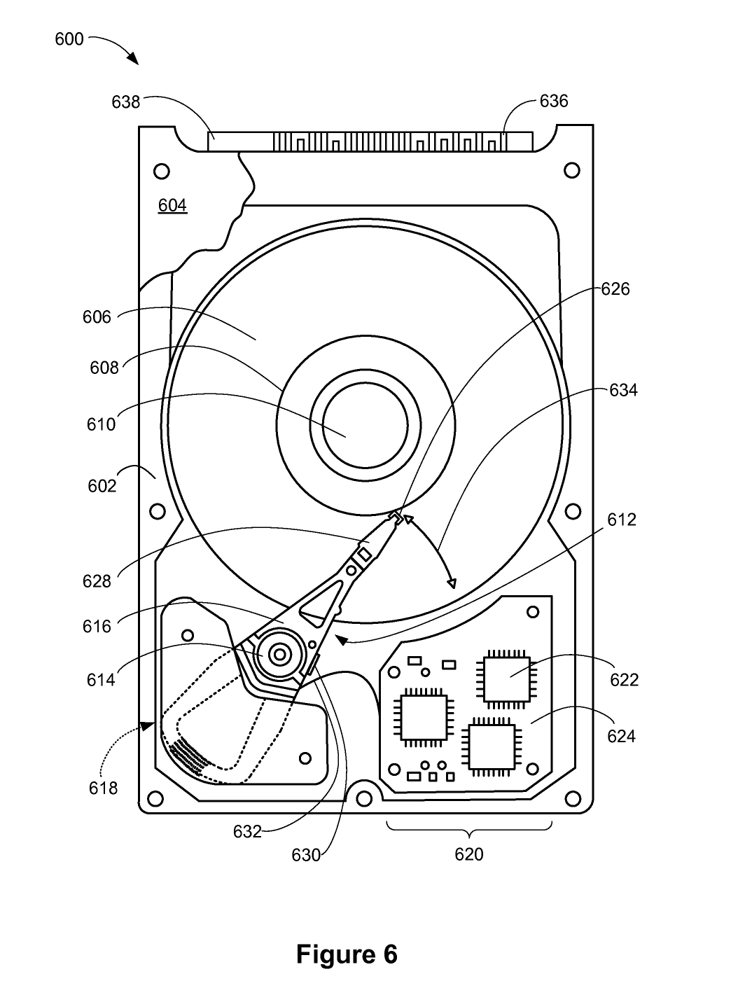

FIG. 6 illustrates an exemplary diagram of a hard drive according to one aspect of the embodiments. FIG. 6 depicts a plan view of a data storage device in which embodiments as described may be implemented is shown. A disk drive 600 generally includes a base plate 602 and a cover 604 that may be disposed on the base plate 602 to define an enclosed housing for various disk drive components. The disk drive 600 includes one or more data storage disks 606 of computer-readable data storage media. Typically, both of the major surfaces of each data storage disk 606 include a plurality of concentrically disposed tracks for data storage purposes. Each data storage disk 606 is mounted on a hub 608, which in turn is rotatably interconnected with the base plate 602 and/or cover 604. Multiple data storage disks 606 are typically mounted in vertically spaced and parallel relation on the hub 608. A spindle motor 610 rotates the data storage disks 606.

The disk drive 600 also includes an actuator arm assembly 612 that pivots about a pivot bearing 614, which in turn is rotatably supported by the base plate 602 and/or cover 604. The actuator arm assembly 612 includes one or more individual rigid actuator arms 616 that extend out from near the pivot bearing 614. Multiple actuator arms 616 are typically disposed in vertically spaced relation, with one actuator arm 616 being provided for each major data storage surface of each data storage disk 606 of the disk drive 600. Other types of actuator arm assembly configurations could be utilized as well, an example being an “E” block having one or more rigid actuator arm tips, or the like, that cantilever from a common structure. Movement of the actuator arm assembly 612 is provided by an actuator arm drive assembly, such as a voice coil motor 618 or the like. The voice coil motor 618 is a magnetic assembly that controls the operation of the actuator arm assembly 612 under the direction of control electronics 620.

The control electronics 620 may include a plurality of integrated circuits 622 coupled to a printed circuit board 624. The control electronics 620 may be coupled to the voice coil motor assembly 618, a slider 626, or the spindle motor 610 using interconnects that can include pins, cables, or wires (not shown).

A load beam or suspension 628 is attached to the free end of each actuator arm 616 and cantilevers therefrom. Typically, the suspension 628 is biased generally toward its corresponding data storage disk 606 by a spring-like force. The slider 626 is disposed at or near the free end of each suspension 628. What is commonly referred to as the read/write head (e.g., transducer) is appropriately mounted as a head unit (not shown) under the slider 626 and is used in disk drive read/write operations. The head unit under the slider 626 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 626 is connected to a preamplifier 630, which is interconnected with the control electronics 620 of the disk drive 600 by a flex cable 632 that is typically mounted on the actuator arm assembly 612. Signals are exchanged between the head unit and its corresponding data storage disk 606 for disk drive read/write operations. In this regard, the voice coil motor 618 is utilized to pivot the actuator arm assembly 612 to simultaneously move the slider 626 along a path 634 and across the corresponding data storage disk 606 to position the head unit at the appropriate position on the data storage disk 606 for disk drive read/write operations.

When the disk drive 600 is not in operation, the actuator arm assembly 612 is pivoted to a “parked position” to dispose each slider 626 generally at or beyond a perimeter of its corresponding data storage disk 606, but in any case in vertically spaced relation to its corresponding data storage disk 606. In this regard, the disk drive 600 includes a ramp assembly (not shown) that is disposed beyond a perimeter of the data storage disk 606 to both move the corresponding slider 626 vertically away from its corresponding data storage disk 606 and to also exert somewhat of a retaining force on the actuator arm assembly 612.

Exposed contacts 636 of a drive connector 638 along a side end of the disk drive 600 may be used to provide connectivity between circuitry of the disk drive 600 and a next level of integration such as an interposer, a circuit board, a cable connector, or an electronic assembly. The drive connector 638 may include jumpers (not shown) or switches (not shown) that may be used to configure the disk drive 600 for user specific features or configurations. The jumpers or switches may be recessed and exposed from within the drive connector 638.

As such, as provided herein is an apparatus, including a motor assembly of a hard disk drive including a shaft of the motor assembly and a first part of the hard disk drive. A first portion of the first part is in contact with a second portion of the shaft and a cross-section extending over an area of contact of the first portion and the second portion is fused. In some embodiments, the first part is thrust cup. In some embodiments, the first part is a top cap. In some embodiments, the first portion of the first part of the hard disk drive and the second portion of the shaft are atomically comingled. In some embodiments, the first portion of the first part of the hard disk drive and the second portion of the shaft are fused via an electric resistance weld. In some embodiments, a joint of the shaft and the first part of the hard disk drive comprises a smooth exterior contour. In some embodiments, the shaft and the first part of the hard disk drive are molecularly bonded via electric resistance welding.

Also provided herein is an apparatus, including a first part of a data storage device and a second part of the data storage drive. The second part of the data storage device is fused to the first part substantially throughout opposing surfaces of the first part and the second part, where the opposing surfaces are in contact with each other. In some embodiments, the first part and the second part are parts of a motor of the data storage device. In some embodiments, the first part is a shaft. In various embodiments, the first part is a top cap. In various embodiments, the second part is a thrust cup. In various embodiments, the shaft includes an opening configured for use in welding. In some embodiments, the first part and the second part are not coupled to a weld nugget.

Also provided is an apparatus, including a first part of a motor assembly of a hard disk drive and a second part of the motor assembly. The first part is welded to the second part via electric resistance welding. In some embodiments, the first part is a shaft and the second part is a thrust cup. In some embodiments, the apparatus may further include a top cap, where the top cap is welded to the shaft via electric resistance welding. In some embodiments, the shaft is a hardened and ground shaft. In some embodiments, a weld of the shaft to the thrust cup extends substantially throughout the area of opposing surfaces of the shaft and the thrust cup. In some embodiments, a first portion of the shaft and a second portion of the thrust cup are cross-sectionally coalesced. In some embodiments, a weld of a first portion of the shaft and a second portion of the thrust cup includes a comingling of the first portion of the shaft and the second portion of the thrust cup.

While particular embodiments have been described and/or illustrated, and while these embodiments and/or examples have been described in considerable detail, it is not the intention of the applicant(s) to restrict or in any way limit the scope of the concepts presented herein to such detail. Additional adaptations and/or modifications may readily appear to persons having ordinary skill in the art, and, in its broader aspects, these adaptations and/or modifications may also be encompassed. Accordingly, departures may be made from the foregoing embodiments and/or examples without departing from the scope of the concepts presented herein, which scope is limited only by the following claims when appropriately construed.

What is claimed is:

1. An apparatus comprising:
a motor assembly of a hard disk drive, comprising:
a shaft of the motor assembly;
a first part of the hard disk drive,
wherein a first portion of the first part is in contact with a second portion of the shaft, and wherein a cross-section extending over an area of contact of the first portion and the second portion is fused.

2. The apparatus of claim 1, wherein the first part is thrust cup.

3. The apparatus of claim 1, wherein the first part is a top cap.

4. The apparatus of claim 1, wherein the first portion of the first part of the hard disk drive and the second portion of the shaft are atomically comingled.

5. The apparatus of claim 1, wherein the first portion of the first part of the hard disk drive and the second portion of the shaft are fused via an electric resistance weld.

6. The apparatus of claim 1, wherein a joint of the shaft and the first part of the hard disk drive comprises a smooth exterior contour.

7. The apparatus of claim 1, wherein the shaft and the first part of the hard disk drive are molecularly bonded via electric resistance welding.

8. An apparatus comprising:
a first part of a data storage device; and
a second part of the data storage device fused to the first part substantially throughout opposing surfaces of the first part and the second part, wherein the opposing surfaces are in contact with each other.

9. The apparatus of claim 8, wherein the first part and the second part are parts of a motor of the data storage device.

10. The apparatus of claim 8, wherein the first part is a shaft.

11. The apparatus of claim 10, wherein the first part is a top cap.

12. The apparatus of claim 10, wherein the second part is a thrust cup.

13. The apparatus of claim 10, wherein the shaft includes an opening configured for use in welding.

14. The apparatus of claim 8, wherein a first portion of the first part fused to a second portion of the second part forms an adhering interface, wherein the adhering interface is substantially coextensive with the area of contact between the first part and the second part.

15. An apparatus comprising:
a first part of a motor assembly of a hard disk drive;
a second part of the motor assembly, wherein the first part is welded to the second part via electric resistance welding.

16. The apparatus of claim 15, wherein the first part is a shaft and the second part is a thrust cup.

17. The apparatus of claim 16, further comprising a top cap, wherein the top cap is welded to the shaft via electric resistance welding.

18. The apparatus of claim 16, wherein the shaft is a hardened and ground shaft.

19. The apparatus of claim 16, wherein a weld of the shaft to the thrust cup extends substantially throughout the area of opposing surfaces of the shaft and the thrust cup.

20. The apparatus of claim 16, wherein a first portion of the shaft and a second portion of the thrust cup are cross-sectionally coalesced.

21. The apparatus of claim 16, wherein the first part comprises a first material that is different from a second material of the second part.
